(19) United States
(12) Patent Application Publication
(10) Pub. No.: US 2025/0326932 A1
(43) Pub. Date: Oct. 23, 2025

(54) LIGNOCELLULOSE- AND CELLULOSE-BASED BIOPRODUCTS

(71) Applicant: North Carolina State University, Raleigh, NC (US)

(72) Inventors: Lokendra Pal, Cary, NC (US); Marian Gayle McCord, Apex, NC (US); Lucian Lucia, Apex, NC (US); Xiaohang Sun, Raleigh, NC (US)

(73) Assignee: North Carolina State University, Raleigh, NC (US)

(21) Appl. No.: 19/255,496

(22) Filed: Jun. 30, 2025

Related U.S. Application Data
(63) Continuation of application No. 16/888,299, filed on May 29, 2020.
(60) Provisional application No. 62/854,047, filed on May 29, 2019.

(51) Int. Cl. C08L 97/02; B33Y 70/00; C08J 3/00; C08J 3/09; C08L 1/12

(52) U.S. Cl. CPC C08L 97/02; B33Y 70/00; C08J 3/005; C08J 3/09; C08L 1/12; C08J 2301/12; C08J 2397/02; C08J 2401/12; C08J 2497/02; C08L 2201/06

(57) ABSTRACT

Disclosed is a composition comprising (a) a lignocellulosic material and/or a cellulosic material; and (b) a cellulose derivative. A process for preparing the composition is also disclosed. The process can comprise providing a cellulose derivative in a solvent; and mixing a lignocellulosic material and/or a cellulosic material into the solvent. The lignocellulosic material and/or the cellulosic material can comprise 90% of particles ranging from 0.01 to 5 mm in size. The lignocellulosic material and/or the cellulosic material can be derived from a biomass residue.

### CROSS-REFERENCE TO RELATED APPLICATIONS

This application is a continuation of U.S. patent application Ser. No. 16/888,299, filed May 29, 2020, which claims benefit of U.S. Provisional Patent Application Ser. No. 62/854,047, filed May 29, 2019, the disclosure of each of which is incorporated herein by reference in its entirety.

### TECHNICAL FIELD

The presently disclosed subject matter relates to lignocellulose-based bioproducts and/or cellulose-based bioproducts.

### BACKGROUND

A petroleum-based plastic known as polystyrene (PS), products of which are commercially available under the registered trademark STYROFOAM®, is the main packaging material for single-use food service items such as drinking cups, dining utensils, containers, etc. Its inherently attractive qualities such as low cost, lightweight, high insulation coefficient, and durability have led to prevalent use in society. However, the STYROFOAM® product also has indirect and hidden costs despite its benefits that are in direct opposition to favorable human health and environmental sustainability. For example, because PS is an extremely chemically stable and non-biodegradable thermoplastic, it has been found to require more than 500 years to decompose. Unfortunately, its production process, limited curbside collection centers, and negative scrap value limits recycling efforts.

Thus, there is a continuing need to find alternative materials, manufacturing technologies, and a supply-chain, to conserve the limited reserve of nonrenewable raw materials, such as fossil-derived synthetic plastics, ceramics and metals, and to develop renewable biomaterials to support future growth in consumption.

### SUMMARY

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

In accordance with some embodiments of the presently disclosed subject matter, provided is a composition comprising (a) a lignocellulosic material and/or a cellulosic material; and (b) a cellulose derivative. In some embodiments, the lignocellulosic material and/or the cellulosic material comprises 90% of particles ranging from 0.01 to 5 mm in size. In some embodiments, the lignocellulosic material is derived from a biomass residue and/or the cellulosic material is derived from a biomass residue. In some embodiments, the biomass residue is selected from the group consisting of a wood biomass residue, such as saw dust; an agricultural biomass residue, such as hemp hurds; and combinations thereof. In some embodiments, the biomass residue is milled, grinded, refined, cryomilled, hammer milled, screened, sieved; and combinations thereof. In some embodiments, the cellulose derivative comprises a cellulose ester. In some embodiments, the composition further comprises a solvent to dissolve cellulose derivative. In some embodiments, the cellulose derivative comprises acetylated cellulose pulp. In some embodiments, the cellulose derivative comprises acetylated high alpha cellulose pulp. In some embodiments, the cellulose derivative comprises acetylated holocellulose pulp. In some embodiments, the cellulose derivative comprises acetylated delignified pulp. In some embodiments, the cellulose derivative comprises acetylated lignocellulosic pulp. In some embodiments, the lignocellulosic material and/or the cellulosic material, and the cellulose derivative are provided at a ratio ranging from 90:10 lignocellulosic material and/or cellulosic material:cellulose derivative to 10:90 lignocellulosic material and/or cellulosic material:cellulose derivative. In some embodiments, the composition further comprises a blowing agent, a dye or other colorant, a cross-linking agent, a plasticizing agent, a release agent, a dry strength agent, a wet strength agent, an enzyme, a nanomaterial, a nanobiomaterial, a rheology modifier, a filler, and combinations thereof. In some embodiments, the composition is characterized as a biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, extrudable, solvent extrudable, reactive extrudable biomaterial, thermoformable, solvent thermoformable, thermoformable biomaterial, and combination thereof.

In accordance with some embodiments of the presently disclosed subject matter, a process for preparing a composition is provided. In some embodiments, the process comprises providing a cellulose derivative in a solvent; and mixing a lignocellulosic material and/or a cellulosic material into the solvent. In some embodiments, the lignocellulosic material and/or the cellulosic material comprises 90% of particles ranging from 0.01 to 5 mm in size. In some embodiments, the lignocellulosic material and/or the cellulosic material is derived from a biomass residue. In some embodiments, the biomass residue is selected from the group consisting of a wood biomass residue, such as saw dust; an agricultural biomass residue such as hemp hurds; and combinations thereof. In some embodiments, the process comprises biomass residue milling, grinding, refining, cryomilling, hammer milling, screening, sieving, and combinations thereof. In some embodiments, the cellulose derivative comprises a cellulose ester. In some embodiments, the process further comprises acetylation of cellulose pulp. In some embodiments, the process further comprises acetylation of high alpha cellulose pulp. In some embodiments, the process further comprises acetylation of holocellulose pulp. In some embodiments, the process further comprises delignification and acetylation of delignified pulp. In some embodiments, the process further comprises acetylation of lignocellulosic pulp. In some embodiments, the lignocellulosic material and/or the cellulosic material, and cellulose derivative are provided at a ratio ranging from 90:10 lignocellulosic material and/or cellulosic material:cellulose derivative to 10:90 lignocellulosic material and/or cellulosic material:cellulose derivative. In some embodiments, the composition further comprises a blowing agent, a dye or other colorant, a cross-linking agent, a plasticizing agent, a release agent, a dry strength agent, a wet strength agent, an enzyme, a nanomaterial, a nanobiomaterial, a rheology modifier, a filler, and combinations thereof. In some embodiments, the solvent comprises acetone. In some embodiments, the process comprises dissolving the cellulose derivative in the solvent and then mixing the lignocellulosic material and/or the cellulosic material into the solvent. In some embodiments, mixing the lignocellulosic material into the solvent occurs under agitation and/or shear. In some embodiments, the process comprises casting the composition in a mold and/or drying the composition. In some embodiments, the process comprises recovering the solvent. In some embodiments, the composition is characterized as a biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, extrudable, solvent extrudable, reactive extrudable biomaterial, thermoformable, solvent thermoformable, thermoformable biomaterial, and combination thereof.

Accordingly, it is an object of the presently disclosed subject matter to provide lignocellulose and cellulose-based castable, moldable, extrudable, reactive extrudable, thermoformable, or printable biomaterials. This and other objects are achieved in whole or in part by the presently disclosed subject matter.

An object of the presently disclosed subject matter having been stated above, other objects and advantages of the presently disclosed subject matter will become apparent to those of ordinary skill in the art after a study of the following description of the presently disclosed subject matter and non-limiting Figures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of an exemplary embodiment of a solvent casting, molding, or 3D printing process, which is suitable for use for various purposes of the presently disclosed subject matter.

FIG. 2 is a graph showing a comparison of the mechanical characteristics (stress and strain at max. load) of various samples corresponding to samples in Table 1.

FIG. 3 is a graph showing a comparison of the mechanical characteristics (load vs. displacement) of various samples corresponding to samples in Table 1.

FIG. 4 is a graph showing a comparison of the density and water vapor transmission rate (WVTR) characteristics of the various samples corresponding to samples in Table 2.

FIG. 5A is a photograph showing solvent casted and compression molded (120° C., 5000 psi) sawdust+cellulose acetate+acetone.

FIG. 5B is a photograph showing solvent casted and compression molded (180° C., 5000 psi) sawdust+cellulose acetate+acetone.

FIG. 5C is a photograph showing powder casted and compression molded (120° C., 20000 psi) sawdust+cellulose acetate.

FIG. 5D is a photograph showing solvent casted and compression molded (120° C., 5000 psi) sawdust+acetone.

FIG. 5E is a photograph showing powder casted and compression molded (180° C., 20000 psi) sawdust only.

FIG. 5F is a photograph showing solvent casted and compression molded (120° C., 5000 psi) cellulose acetate+acetone.

FIG. 5G is a photograph showing powder casted and compression molded (120° C., 5000 psi) cellulose acetate only.

FIG. 6 is a set of photographs showing a solvent molded and printed (spray system) or dyed and surface coated pieces.

FIG. 7 is a set of photographs machinability (drilled, cut and rubbed) of solvent casted pieces.

FIG. 8 is a photograph showing solvent molded pieces containing additives such as triethyl citrate (TEC) and ethylated starch.

FIG. 9 is a schematic diagram showing a process in accordance with the presently disclosed subject matter, employing a cellulose derivative from commercial sources.

FIG. 10 a schematic diagram showing a process in accordance with the presently disclosed subject matter, employing a cellulose derivative prepared by derivatization of cellulose fibers and other cellulosic materials.

FIG. 11 is a schematic diagram showing a process in accordance with the presently disclosed subject matter, employing a cellulose derivative prepared by delignification and derivatization of lignocellulosic materials.

FIG. 12 is a set of photographs showing effect of sawdust particle size refined using a Wiley mill grinder.

FIG. 13 is a set of photographs showing mold casted cellulose material/cellulose derivative (3:1).

FIG. 14A is a photograph showing a solvent casted flexible block prepared from Refined Sawdust/Cellulose Acetate (1:1) with plasticizing and crosslinking agents.

FIG. 14B is a photograph showing a solvent casted flexible block prepared from Refined Sawdust/Cellulose Acetate (3:1) with plasticizing and crosslinking agents.

FIG. 15A is a photograph showing a control sawdust (grinded using Wiley mill grinder).

FIG. 15B is a photograph showing RSD (grinded using the Wiley mill grinder followed by Flacktec SpeedMixer™).

FIG. 15C is a SEM image of control sawdust (grinded using Wiley mill grinder).

FIG. 15D is a SEM image of RSD (grinded using the Wiley mill grinder followed by Flacktec SpeedMixer™).

FIG. 16A is a photograph showing a RSD/CA (1:1) sample with pressure

FIG. 16B is a photograph showing a RSD/CA (1L1) sample without pressure.

FIG. 16C is a schematic image of lignocellulose composite system.

FIG. 17 is a photograph showing a cross-section of RSD/CA (1:1) samples.

FIG. 18A is a photograph showing mold casted SD/CA (3:1) chess pieces.

FIG. 18B is a photograph showing mold casted RSD/CA (3:1) chess pieces.

FIG. 19A is a photograph showing a polystyrene packing peanut.

FIG. 19B is a photograph showing a RSD/CA (3:1) packing peanut.

FIG. 20A is a photograph showing a skeleton mask made of SD/CA (3:1).

FIG. 20B is a photograph showing a skeleton mask made of RSD/CA (3:1).

### DETAILED DESCRIPTION

Lignocellulose, cellulose, and derivatives thereof exhibit significant potential as an alternative for fossil-derived plastic products due to their renewability, biocompostability, biodegradability, biocompatibility, and sustainability. The presently disclosed subject matter pertains at least in part to biocomposite materials from lignocellulose renewable resources generated as the industrial waste byproducts that are either burned in hog fuel boiler or sent to landfill. In accordance with the presently disclosed subject matter, it is possible to tailor desired properties such as density, porosity, water resistance, strength, color, texture, machinability, and flexibility as needed for specific market applications by controlling the biomaterials and process parameters. In some embodiments, the presently disclosed formulations contain up to 90% sawdust or cellulose powder.

### I. Definitions

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

While the following terms are believed to be well understood by one of ordinary skill in the art, the following definitions are set forth to facilitate explanation of the presently claimed subject matter.

Following long-standing patent law convention, the terms “a”, “an”, and “the” refer to “one or more” when used herein, including in the claims.

As used herein, the term “about”, when referring to a value or an amount, for example, relative to another measure, is meant to encompass variations of in some embodiments ±20%, in some embodiments ±10%, in some embodiments ±5%, in some embodiments ±1%, and in some embodiments ±0.1% from the specified value or amount, as such variations are appropriate. The term “about” can be applied to all values set forth herein.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, “significance” or “significant” relates to a statistical analysis of the probability that there is a non-random association between two or more entities. To determine whether or not a relationship is “significant” or has “significance”, statistical manipulations of the data can be performed to calculate a probability, expressed in some embodiments as a “p-value”. Those p-values that fall below a user-defined cutoff point are regarded as significant. In some embodiments, a p-value less than or equal to 0.05, in some embodiments less than 0.01, in some embodiments less than 0.005, and in some embodiments less than 0.001, are regarded as significant.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

### II. Representative Embodiments

The presently disclosed subject matter will now be described more fully hereinafter with reference to the accompanying Figures, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art. Certain components in the Figures are not necessarily to scale, emphasis instead being placed upon illustrating the principles of the presently disclosed subject matter (in some cases schematically).

In accordance with aspects of the presently disclosed subject matter, waste and low value industrial byproducts are developed into higher value biomaterials for packaging, construction, agriculture, and other related applications to replace assortment of plastic products, including polystyrene. The presently disclosed subject matter provides biomaterial formulations, and processing methods to achieve the specified goals.

In some embodiments, the presently disclosed processes comprise first blending lignocellulose and/or cellulosic powder with a cellulose derivative, and then converting it to innovative packaging materials via casting, molding, extruding, thermoforming, and/or 3D printing with an appropriate solvent.

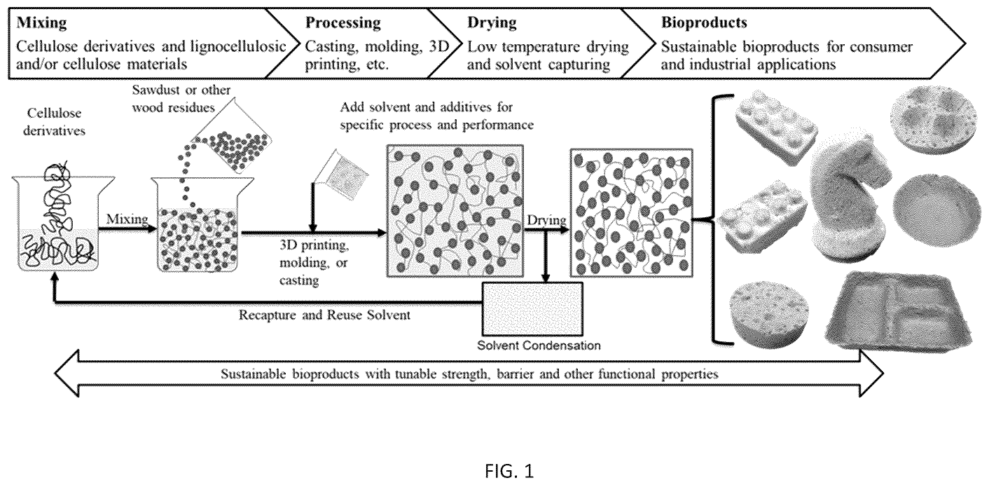

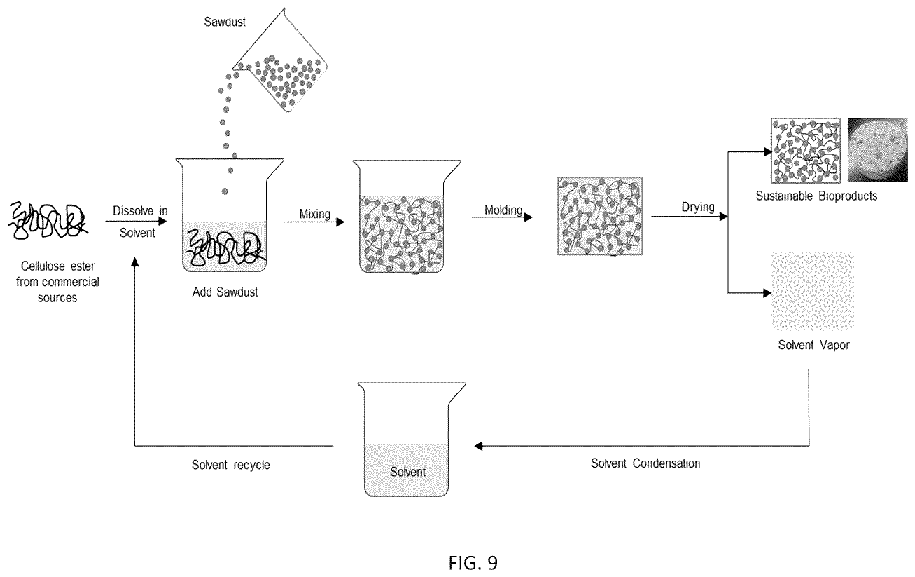

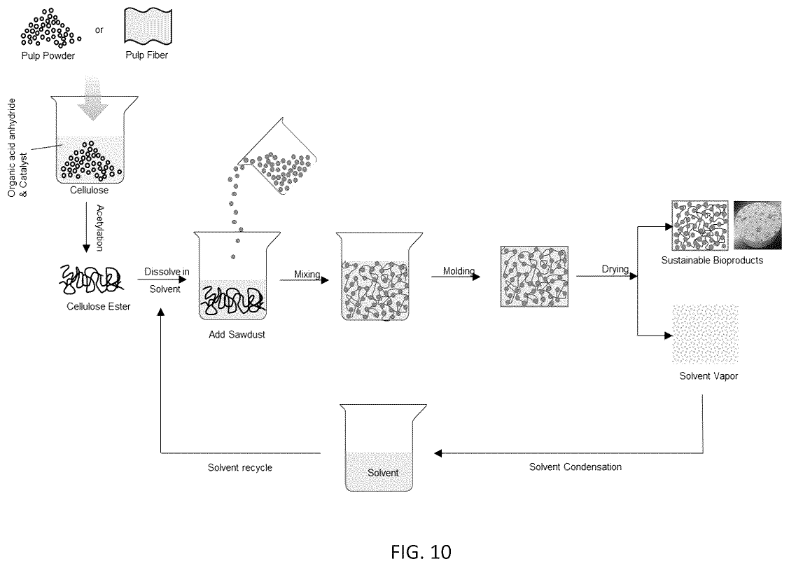

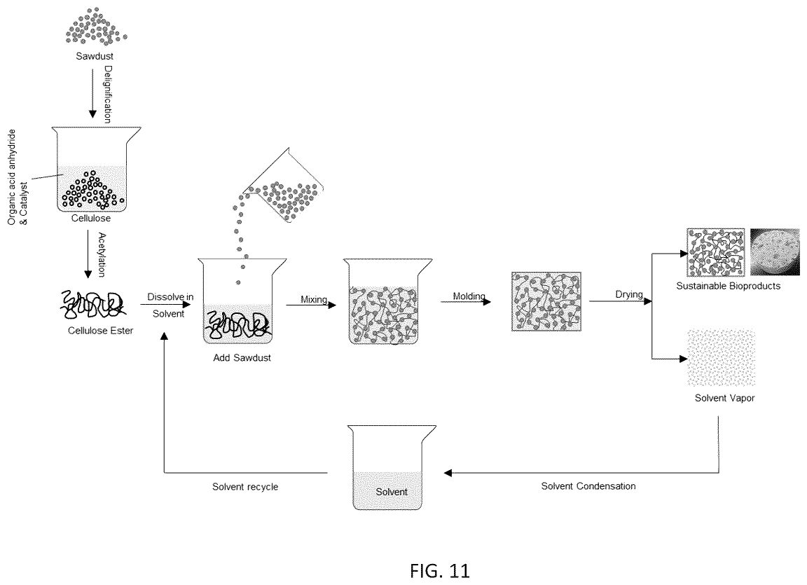

Thus, in accordance with some embodiments of the presently disclosed subject matter a composition comprising a lignocellulosic material and/or a cellulosic material (e.g., a powder) and a cellulose derivative is provided. In some embodiments, the lignocellulosic material and/or the cellulosic material comprises 90% of particles 5 millimeters (mm) or less in size. In some embodiments, the lignocellulosic material and/or the cellulosic material comprises 90% of particles ranging from 0.01 to 5 mm in size. In some embodiments, the lignocellulosic material and/or the cellulosic material comprises 80% of particles 3 mm or less in size. In some embodiments, the lignocellulosic material and/or the cellulosic material comprises 70% of particles 1.5 mm or less in size. In some embodiments, the lignocellulosic material and/or the cellulosic material comprises 50% of particles 0.6 mm (600 microns) or less in size. In some embodiments, the lignocellulosic material and/or the cellulosic material comprises 30% of particles 0.3 mm (300 microns) or less in size. In some embodiments, the lignocellulosic material and/or the cellulosic material comprises 75% of particles 0.1 mm (300 microns) or less in size. In some embodiments, the composition is characterized as a biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, extrudable biomaterial, solvent extrudable biomaterial, reactive extrudable biomaterial, thermoformable biomaterial, solvent thermoformable biomaterial, thermoformable biomaterial, and combination thereof. In some embodiments, the biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, and combination thereof is further coated, spray printed or dyed, calendared or embossed. See also FIGS. 1 and 9-11.

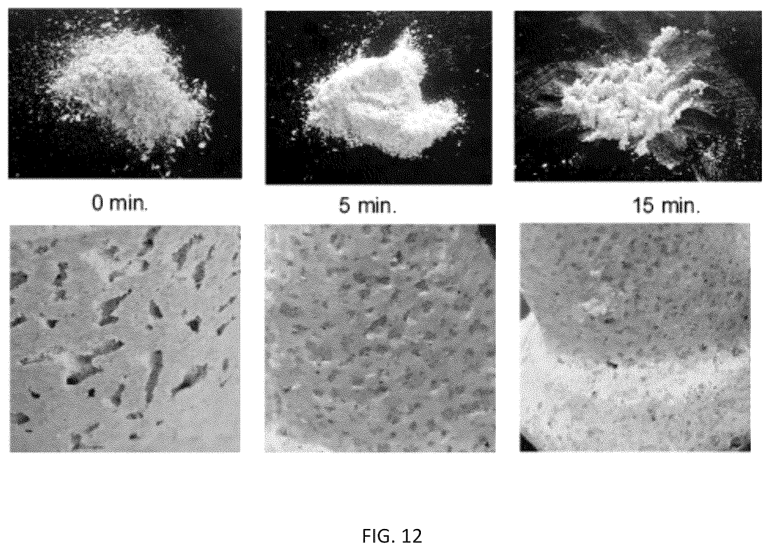

In some embodiments, the lignocellulosic material and/or the cellulosic material is derived from a biomass residue. In some embodiments, the biomass residue is selected from the group comprising a wood biomass residue, such as saw dust; an agricultural biomass residue; and combinations thereof. By way of particular, non-limiting example, sawdust or wood dust is a granular lignocellulosic waste byproduct from lumber mills and other industrial wood users as a result of cutting, grinding, drilling, sanding or pulverizing of wood with a saw or machining tools. It mainly comprises cellulose, hemicellulose, lignin and extractives, whose typical grain dimensions vary from 0.1 (100 μm) mm to 5 mm where 30% of particles are 0.3 mm or less, 50% of particles are 0.6 mm or less, 70% of particles are 1.5 mm or less, 80% of particles are 3 mm or less, and 90% of particles 5 mm or less. A specific grain size can be achieved by screening or grinding or combination thereof. A representative commercially available grinder is a Wiley mill grinder. Grinding time periods can vary, depending on desired particle size, and can include 0 to 15 minutes and any time point in between, including 5 minutes. Further, grinding of the sawdust can be done using a Flacktek SpeedMixer™, which refines the sawdust using a Dual Asymmetric Centrifugal Laboratory Mixer System that generates high shear force, to provide Refined Sawdust (RSD). See, for example, FIGS. 12, 13, 14A, and 14B, discussed herein below.

Other sources of wood residues are paper mills (e.g., sludge, dust, waste fibers, etc.), lumber mills and other industrial wood users (e.g., sawdust, pallets, shavings, flour, etc.), discarded wood products or wood yard trimmings diverted from landfills, and non-hazardous wood debris from construction and demolition activities. Traditionally it is burned in a hog fuel boiler or used for wood pallets heating materials, particle board and pressed board materials. A large-scale usage of wood waste still remains a major problem with only partial solutions have developed. A significant environmental-economic tandem benefit of using these materials is that significant solid waste accumulation in landfill is avoided, while their value is significantly upgraded. There is a total of over 65 million tons per year wood-waste including over 25 million tons/year non-recycled wood-waste. S. Bratkovich, J. Howe, J. Bowyer, E. Pepke, M. Frank, K. Fernholz (2014) Municipal Solid Waste (Msw) and Construction and Demolition (C&D) Wood Waste Generation and Recovery in the United States (dovetailinc.org/report_pdfs/2014/dovetailwoodrecovery0914.pdf). Recent studies indicate that quantities of available (presently unused) mill and urban wood residues exceed 39 million dry tons per year in the United States.

A “cellulosic material” can be prepared from a lignocellulosic material as described herein, using additional chemical treatments including but not limited to the kraft and sulfite chemical pulping processes, where most of the lignin and hemicellulose components are removed, organo-solvent pulping, semichemical pulping, chemi-thermomechanical pulping (CTMP), thermomechanical pulping (TMP), hydrothermal pulping, autohydrolysis pulping, alkaline pulping or may use any such single or combination of chemical and mechanical treatments, or may be subjected to any other pulping approaches, to remove hemicellulose, lignin and/or extractives, as would be apparent to one of ordinary skill in the art upon a review of the instant disclosure. Bleaching chemicals such as hydrogen peroxide, oxygen, enzymes, chlorine dioxide, hypochlorite, ozone, and other bleaching agents may be used in combinations to whiten the “cellulosic material.”

Here as well, typical grain dimensions vary from 0.1 (100 μm) mm to 5 mm where 30% of particles are 0.3 mm or less, 50% of particles are 0.6 mm or less, 70% of particles are 1.5 mm or less, 80% of particles are 3 mm or less, and 90% of particles 5 mm or less. The most common sources of cellulosic materials are wood fibers, plant fibers, cotton linters or combination thereof. In some embodiments, the cellulosic fibers are selectively derived from hardwood or softwood. In some embodiments, the cellulosic fibers are selectively derived from agriculture biomass residue such as bagasse, wheat straw, whole hemp, and/or hemp hurds. In some embodiments, lignocellulosic or cellulosic materials are chemically or biologically treated in a wet state to achieve the desired grain size. The chemical treatment may include mild alkaline (NaOH) or acidic (Acetic Acid) or enzymes (such as enzymes commercially available under the registered trademark CELLIC® Ctec3 or HTec3). The temperature during chemical treatment may range from room temperature to 220° C. from 10 minutes to 12 hours. In some embodiments, lignocellulosic or cellulosic materials are biologically treated after chemical treatment in a wet state to achieve the desired grain size. In some embodiments, lignocellulosic or cellulosic materials are mechanically refined in a wet state to achieve the desired grain size. In some embodiments, lignocellulosic or cellulosic materials are mechanically refined after chemical or biological treatments in a wet state to achieve the desired grain size. In some embodiments, lignocellulosic or cellulosic materials are chemical or biological treatments under intense mechanical refining or grinding in a wet or dry state to achieve the desired grain size using a FlackTek SpeedMixer™ or DDR (Double Disc Refiner). The refining intensity can be measured using a freeness tester (e.g., targeting a certain freeness number according to the Canadian Standard Method (CSF) test). In some embodiments, refining of the lignocellulosic and cellulosic in water is targeted to provide a freeness number lower than about 200, and more preferably, refining of the lignocellulosic and cellulosic in water is targeted to provide a freeness number ranging from about 100 to about 500. After refining, the lignocellulosic and cellulosic biomaterials may be passed through a vibrating screen or sieved, which removes larger debris, but allows the desired size biomaterial to pass through the screen.

The term “cellulose derivative” refers to a product of a reaction of cellulose with a reagent. In some embodiments, the cellulose derivative comprises a cellulose ester derivative. Representative cellulose esters include cellulose acetate, cellulose diacetate, cellulose triacetate, cellulose propionate, cellulose butyrate, cellulose tripropionate, and the co-esters cellulose acetate-propionate, and cellulose acetate-butyrate. Further, cellulose derivatives can have a low degree of substitution (DS) of <1, medium DS of <2 or high DS of >2 depending on the type and the amount of chemical reagents, type of cellulosic materials, reaction time, temperature and combinations thereof, Cellulose ester derivatives with low DS can be highly soluble in water whereas cellulose derivatives with high DS are generally water insoluble polymers with good film forming characteristics. Commercially available cellulose derivatives may further include plasticizers and crosslinkers, such as those described elsewhere herein.

In some embodiments, the cellulose derivative comprises acetylated cellulose pulp. In some embodiments, the cellulose derivative comprises acetylated high alpha cellulose pulp. In some embodiments, the cellulose derivative comprises acetylated holocellulose pulp. In some embodiments, the cellulose derivative comprises acetylated delignified pulp. In some embodiments, the cellulose derivative comprises acetylated lignocellulosic pulp.

In some embodiments, the lignocellulosic material (typically provided as a powder) and/or the cellulosic material (typically provided as a powder) and cellulose derivative are provided at a ratio ranging from 90:10 lignocellulosic material and/or cellulosic material:cellulose derivative to 10:90 lignocellulosic material and/or cellulosic material:cellulose derivative. Thus, some embodiments of the presently disclosed compositions comprise up to about 90% of the lignocellulosic material and/or cellulosic material, including about 90% saw dust. Ratios can be changed for tuning characteristics of the composition such as strength, porosity, density, and the like. The composition can also be adapted for use in a casting, for use in a molding, and for use in 3-D printing. In some embodiments the lignocellulosic material and/or cellulosic material is/are provided in a ratio of about 50% or higher as compared to the cellulose derivative; in some embodiments 75% or higher; in some embodiments 90% or higher. In some embodiments the lignocellulosic material and/or cellulosic material is/are provided at a range of about 50-90% by weight. In some embodiments, then, the cellulose derivative is provided at 10-50% concentration by weight. In some embodiments the lignocellulosic material is provided at a range of about 50-90% by weight. In some embodiments, then, the cellulosic material is provided at 5-30% concentration by weight. In some embodiments, then, the cellulose derivative is provided at 5-20% concentration by weight.

In some embodiments the lignocellulosic material is provided at a range of about 50-90% by weight. In some embodiments, then, the cellulosic material is provided at 9-40% concentration by weight. In some embodiments, then, the cellulose derivative is provided at 1-10% concentration by weight. Particle size choices can be selected based on a desired characteristic for the composition. For example, porosity and surface resolution texture/smoothness can be addressed when a small particle size is chosen. In some cases, such smoother surfaces can be used for packaging material end uses. In some embodiments a lower porosity and a smoother surface might be desired for example in the end use of a disposable plate for use in dining. Thus, grinding, milling, cryomilling, cryogrinding, refining, screening, fractionating, mixing or other similar processes are chosen to provide different particle sizes for subsequent inclusion in a composition in accordance with the presently disclosed subject matter.

Thus, lignocellulosic materials and/or cellulosic materials, including materials comprising cellulose fibers, can be ground to provide submillimeter to micron size particles, for example, where 30% of particles are 0.3 mm (300 μm) or less, 50% of particles are 0.6 mm (600 μm) or less, 70% of particles are 1.5 mm or less, 80% of particles are 3 mm or less, and 90% of particles 5 mm or less. In some embodiments the lignocellulosic material and cellulosic materials (e.g., cellulose fibers) are processed separately while in other cases lignocellulosic material is co-processed with the cellulosic material (e.g., cellulose fibers).

As mentioned above, smaller particle sizes can provide predetermined or desired surface quality, porosity and strength in some embodiments. For example, in some embodiments, 30% of particle size comprising 300 μm or less are pursued. In some embodiments, 50% of particle sizes comprising about 600 μm or less are pursued. Thus, particle size ranges can be chosen depending on client or customer need for desired inputs. Additionally, various chemistries can be applied to the composition, which again can depend on desired end uses. For example, a cross-linking agent can be added to the composition, which can provide for curing of the composition to make it harder. Exemplary cross-linking agents include but are not limited to amino resins, anhydrides, dialdehydes (glyoxal and glutaraldehyde), acetals (1,1,4,4-tetramethoxybutane and 1,1,5,5-tetramethoxybutane), polycarboxylic acids (acrylic, maleic, polymaleic, succinic polyitaconic and citric acids), phosphorus derivatives (phosphoric acid and triethyl phosphate), silica derivatives (tetraethoxysilane), epichlorohydrin and polyepichlorohydrin. Cross-linking agents can also be chosen based on characteristics of the mixture created in making the presently disclosed composition, e.g. the pH of the mixture or manufacturing parameters such as curing temperature. Further, composition characteristics can be changed by modifying the pH of the mixture or temperature in addition to adding a cross-linking agent. In some embodiments, the composition further comprises a sizing agent, blowing agent, a dye or other colorant, a plasticizing agent, a cross-linking agent, a dry strength agent, a wet strength agent, an enzyme, a rheology modifier, a nanomaterial, a nanobiomaterial, a filler and combinations thereof. Blowing agents can be used to expand the composition and to enhance lightweight characteristics. Representative blowing agents include but are not limited to physical blowing agents, chemical blowing agents or combination of chemical and physical blowing agents. Examples are hydrocarbons (e.g., pentane, isopentane, cyclopentane), gas or liquid CO₂, gas or liquid N₂, air, sodium bicarbonate, and/or combinations thereof. Additional additives can include sizing agent, such as rosins and rosin derivatives, alkyl ketene dimer (AKD); plasticizing agent, such as bio-based plasticizers (triethyl citrate (TEC), acetyl triethyl citrate (ATEC), acetyl triethyl citrate (ATEC), tributyl citrate (TBC), acetyl tributyl citrate (ATBC), trioctyl citrate (TOC), butyryl trihexyl citrate (BTHC, trihexyl o-butyryl citrate), trimethyl citrate (TMC)), discarbolic/tricarboxylic ester-based plasticizers, adipates-based plasticizers, sebacates-based plasticizers, and/or maleates-based plasticizers, as well as glycerol, glycerol triacetate, tributyl citrate, polyethylene glycol, and the like; a releasing agent, such as silicone and oil-based materials, and/or stearate and stearic acid-based materials; a dry strength agent, such starches, oxidized starch, ethylated starch, enzymatically treated starch, sodium alginate, proteins, soy lecithin proteins, and/or dextrin, dyes or other colorants, such PERGOSOAL red, and/or methylene blue; a filler such as titanium dioxide, clay, carbonate, a nanomaterial, such as nano titanium oxide, and/or nano silica; a nanobiomaterial, such as nanocellulose, nanofibrillated cellulose, nanocrystals, and/or nanocellulose crystals; rheology modifiers, such as methylcellulose, ethylcellulose, hydroxyethylcellulose, hydroxypropylcellulose, and/or their derivatives. Representative concentrations for such additives can be in the range of about 1% to about 30% by weight, for example.

In some embodiments, the presently disclosed subject matter provides a process for preparing a composition. In some embodiments, the process comprises providing (for example, dissolving) a cellulose derivative in a solvent; and mixing a lignocellulosic material and/or cellulosic material (e.g., a lignocellulosic powder and/or cellulosic powder) into the solvent. In some embodiments, the lignocellulosic material and/or cellulosic material comprises 90% of particles 5 millimeters (mm) or less in size. In some embodiments, the lignocellulosic material and/or cellulosic material comprises 80% of particles 3 mm or less in size. In some embodiments, the lignocellulosic material and/or cellulosic material comprises 70% of particles 1.5 mm or less in size. In some embodiments, the lignocellulosic material and/or cellulosic material comprises 50% of particles 0.6 mm (600 microns) or less in size. In some embodiments, the lignocellulosic material and/or cellulosic material comprises 30% of particles 0.3 mm (300 microns) or less in size. In some embodiments, the composition is characterized as a biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, extrudable, solvent extrudable, reactive extrudable biomaterial, thermoformable, solvent thermoformable, thermoformable biomaterial, and combination thereof. See also FIGS. 1 and 9-11.

In some embodiments, the lignocellulosic material and/or cellulosic material is derived from a biomass residue. In some embodiments, the biomass residue is selected from the group comprising a wood biomass residue, such as saw dust; an agricultural biomass residue; and combinations thereof. By way of particular, non-limiting example, sawdust or wood dust is a granular lignocellulosic waste byproduct from lumber mills and other industrial wood users as a result of cutting, grinding, drilling, sanding or pulverizing of wood with a saw or machining tools. It mainly comprises cellulose, hemicellulose, lignin and extractives, whose average grain dimensions vary from 0.1 mm (100 μm) to 5 mm where 30% of particles are 0.3 mm or less, 50% of particles are 0.6 mm or less, 70% of particles are 1.5 mm or less, 80% of particles are 3 mm or less, and 90% of particles 5 mm or less. A specific grain size can be achieved by screening or grinding or combination of other sources of wood residues are paper mills (e.g., sludge, dust, waste fibers, etc.), lumber mills and other industrial wood users (e.g., sawdust, pallets, shavings, flour, etc.), discarded wood products or wood yard trimmings diverted from landfills, and non-hazardous wood debris from construction and demolition activities. Traditionally it is burned in a hog fuel boiler or used for wood pallets heating materials, particle board and pressed board materials. A large-scale usage of wood waste still remains a major problem with only partial solutions have developed. A significant environmental-economic tandem benefit of using these materials is that significant solid waste accumulation in landfill is avoided, while their value is significantly upgraded. There is a total of over 65 million tons per year wood-waste including over 25 million tons/year non-recycled wood-waste. S. Bratkovich, J. Howe, J. Bowyer, E. Pepke, M. Frank, K. Fernholz (2014) Municipal Solid Waste (Msw) and Construction and Demolition (C&D) Wood Waste Generation and Recovery in the United States (dovetailinc.org/report_pdfs/2014/dovetailwoodrecovery0914.pdf). Recent studies indicate that quantities of available (presently unused) mill and urban wood residues exceed 39 million dry tons per year in the United States.

A “cellulosic material” can be prepared from a lignocellulosic material as described herein, using additional chemical treatments including but not limited to the kraft and sulfite chemical pulping processes, where most of the lignin and hemicellulose components are removed, organo-solvent pulping, semichemical pulping, chemi-thermomechanical pulping (CTMP), thermomechanical pulping (TMP) or may use any such single or combination of chemical and mechanical treatments, or may be subjected to any other pulping approaches, to remove hemicellulose, lignin and/or extractives, as would be apparent to one of ordinary skill in the art upon a review of the instant disclosure. Here as well, typical grain dimensions vary from 0.1 (100 μm) mm to 5 mm where 30% of particles are 0.3 mm or less, 50% of particles are 0.6 mm or less, 70% of particles are 1.5 mm or less, 80% of particles are 3 mm or less, and 90% of particles 5 mm or less. The most common sources of cellulosic materials are wood fibers, plant fibers, cotton linters or combination thereof. In some embodiments, the cellulosic fibers are selectively derived from hardwood or softwood. In some embodiments, the cellulosic fibers are selectively derived from agriculture biomass residue such as bagasse and/or wheat straw. In some embodiments, lignocellulosic or cellulosic materials is mechanically refined in a wet state to achieve the desired grain size. The refining intensity can be measured using a freeness tester (e.g., targeting a certain freeness number according to the Canadian Standard Method (CSF) test). In some embodiments, refining of the lignocellulosic and cellulosic in water is targeted to provide a freeness number lower than about 200, and more preferably, refining of the of the lignocellulosic and cellulosic in water is targeted to provide a freeness number ranging from about 100 to about 500. After refining, the lignocellulosic and cellulosic biomaterials may be passed through a vibrating screen, which removes larger debris, but allows the desired size biomaterial to pass through the screen.

The term “cellulose derivative” refers to a product of a reaction of cellulose with a reagent. In some embodiments, the cellulose derivative comprises a cellulose ester derivative. Representative cellulose esters include cellulose acetate, cellulose diacetate, cellulose triacetate, cellulose propionate, cellulose butyrate, cellulose tripropionate, and the co-esters cellulose acetate-propionate, and cellulose acetate-butyrate. Further, cellulose derivatives can have a low degree of substitution (DS) of <1, medium DS of <2 or high DS of >2 depending on the type and the amount of chemical reagents, type of cellulosic materials, reaction time, temperature and combinations thereof, Cellulose ester derivatives with low DS can be highly soluble in water whereas cellulose derivatives with high DS are generally water insoluble polymers with good film forming characteristics. Commercially available cellulose derivatives may further include plasticizers and crosslinkers, such as those described elsewhere herein.

In some embodiments, the process further comprises acetylation of cellulose pulp. In some embodiments, the process further comprises acetylation of high alpha cellulose pulp. In some embodiments, the process further comprises acetylation of holocellulose pulp. In some embodiments, the process further comprises delignification and acetylation of delignified pulp. In some embodiments, the process further comprises acetylation of lignocellulosic pulp.

In some embodiments, the lignocellulosic material (typically provided as a powder) and/or the cellulosic material (typically provided as a powder) and cellulose derivative are provided at a ratio ranging from 90:10 lignocellulosic material and/or cellulosic material:cellulose derivative to 10:90 lignocellulosic material and/or cellulosic material:cellulose derivative. Thus, some embodiments of the presently disclosed compositions comprise up to about 90% of the lignocellulosic material and/or cellulosic material, including about 90% saw dust. Ratios can be changed for tuning characteristics of the composition such as strength, porosity, density, and the like. The composition can also be adapted for use in a casting, for use in a molding, and for use in 3-D printing. In some embodiments the lignocellulosic material and/or the cellulosic material is/are provided in a ratio of about 50% or higher as compared to the cellulose derivative; in some embodiments 75% or higher; in some embodiments 90% or higher. In some embodiments the lignocellulosic material and/or the cellulosic material is/are provided at a range of about 50-90% by weight. In some embodiments, then, the cellulose derivative is provided at 10-50% concentration by weight. In some embodiments the lignocellulosic material is provided at a range of about 50-90% by weight. In some embodiments, then, the cellulosic material is provided at 5-30% concentration by weight. In some embodiments, then, the cellulose derivative is provided at 5-20% concentration by weight.

In some embodiments the lignocellulosic material is provided at a range of about 50-90% by weight. In some embodiments, then, the cellulosic material is provided at 9-40% concentration by weight. In some embodiments, then, the cellulose derivative is provided at 1-10% concentration by weight.

Particle size choices can be selected based on a desired characteristic for the composition. For example, porosity and surface resolution texture/smoothness can be addressed when a small particle size is chosen. In some cases, such smoother surfaces can be used for packaging material end uses. In some embodiments a lower porosity and a smoother surface might be desired for example in the end use of a disposable plate for use in dining. Thus, grinding, milling, refining, fractionating, mixing, or other similar processes are chosen to provide different particle sizes for subsequent inclusion in a composition in accordance with the presently disclosed subject matter. See also FIGS. 1 and 9-11.

Thus, lignocellulosic materials and/or cellulosic materials, including materials comprising cellulose fibers, can be ground to provide submillimeter to micron size particles, for example, where 30% of particles are 0.3 mm (300 μm) or less, 50% of particles are 0.6 mm (600 μm) or less, 70% of particles are 1.5 mm or less, 80% of particles are 3 mm or less, and 90% of particles 5 mm or less. In some embodiments the lignocellulosic material and cellulosic materials (e.g., cellulose fibers) are processed separately while in other cases lignocellulosic material is co-processed with the cellulosic material (e.g., cellulose fibers). As mentioned above, smaller particle sizes can provide predetermined or desired surface quality, porosity and strength in some embodiments. For example, in some embodiments, 30% of particle sizes comprising 300 μm or less are pursued. In some embodiments, 50% of particle sizes comprising about 600 μm or less are pursued. Thus, particle size ranges can be chosen depending on client or customer need for desired inputs.

In some embodiments, an additive is provided to the composition, such as a blowing agent, a dye or other colorant, a cross-linking agent, a dry strength agent, a wet strength agent, and combinations thereof. Additional additives can include cross-linking agents and dyes. Representative concentrations for such additives can be in the range of about 1% to about 30% by weight, including about 10% by weight, for example. Additionally, various chemistries can be applied to the composition, which again can depend on desired end uses. For example, a cross-linking agent can be added to the composition, which can provide for curing of the composition to make it harder. Exemplary cross-linking agents include but are not limited to amino resins, anhydrides, dialdehydes (glyoxal and glutaraldehyde), acetals (1,1,4,4-tetramethoxybutane and 1,1,5,5-tetramethoxybutane), polycarboxylic acids (acrylic, maleic, polymaleic, succinic polyitaconic and citric acids), phosphorus derivatives (phosphoric acid and triethyl phosphate), silica derivatives (tetraethoxysilane), epichlorohydrin and polyepichlorohydrin. Cross-linking agents can also be chosen based on characteristics of the mixture created in making the presently disclosed composition, e.g. the pH of the mixture or manufacturing parameters such as curing temperature. Further, composition characteristics can be changed by modifying the pH of the mixture or temperature in addition to adding a cross-linking agent. In some embodiments, the composition further comprises a sizing agent, blowing agent, a dye or other colorant, a plasticizing agent, a cross-linking agent, a dry strength agent, a wet strength agent, an enzyme, a rheology modifier, a nanomaterial, a nanobiomaterial, a filler and combinations thereof. Blowing agents can be used to expand the composition and to enhance lightweight characteristics. Representative blowing agents include but are not limited to physical blowing agents, chemical blowing agents or combination of chemical and physical blowing agents. Examples are hydrocarbons (e.g., pentane, isopentane, cyclopentane), gas or liquid CO₂, gas or liquid N₂, air, sodium bicarbonate, and/or combinations thereof. Additional additives can include sizing agent, such as rosins and rosin derivatives, alkyl ketene dimer (AKD); plasticizing agent, such as bio-based plasticizers (triethyl citrate (TEC), acetyl triethyl citrate (ATEC), acetyl triethyl citrate (ATEC), tributyl citrate (TBC), acetyl tributyl citrate (ATBC), trioctyl citrate (TOC), butyryl trihexyl citrate (BTHC, trihexyl o-butyryl citrate), trimethyl citrate (TMC)), discarbolic/tricarboxylic ester-based plasticizers, adipates-based plasticizers, sebacates-based plasticizers, and/or maleates-based plasticizers, as well as glycerol, glycerol triacetate, tributyl citrate, polyethylene glycol, and the like; a releasing agent, such as silicone and oil-based materials, and/or stearate and stearic acid-based materials; a dry strength agent, such starches, oxidized starch, ethylated starch, enzymatically treated starch, sodium alginate, proteins, soy lecithin proteins, and/or dextrin, dyes or other colorants, such PERGOSOAL red, and/or methylene blue; a filler such as titanium dioxide, clay, carbonate, a nanomaterial, such as nano titanium oxide, and/or nano silica; a nanobiomaterial, such as nanocellulose, nanofibrillated cellulose, nanocrystals, and/or nanocellulose crystals; rheology modifiers, such as methylcellulose, ethylcellulose, hydroxyethylcellulose, hydroxypropylcellulose, and/or their derivatives. Representative concentrations for such additives can be in the range of about 1% to about 30% by weight, including 10% by weight, for example.

In some embodiments, mixing the lignocellulosic material and/or cellulosic material into the solvent occurs under shear and/or agitation. In some embodiments of the presently disclosed process, a solvent is chosen based on a boiling point of the solvent. For example, low boiling point solvents can be chosen. The various classes of solvents such as non-polar and polar among which protic and non-protic, halogenated, non-halogenated can further be selected. Suitable examples of solvents include but are not limited to acetone, acetic acid, methyl acetate, ethyl acetate, butyl acetate, dimethylacetamide (DMA), and dimethylformamide (DMF). Acetone is an example of a low boiling point solvent. Further, in some embodiments, the solvent is used to dissolve the cellulose derivative usually under high shear. Furthermore, in some embodiments, full dissolution of cellulose derivatives such as high DS (degree of substitution) cellulose triacetate (CTA) in acetone, the mixture is exposed to a cryogenic agent such as liquid nitrogen then defreeze multiple times until CTA completely dissolves in acetone. The solvent can be recycled and, in some embodiments, greater than 95% or approximately 99% of the solvent can be recovered. In some embodiments, waterless processing is considered when making solvent choices. In some embodiments, water can be used to exchange low boiling point solvent such as acetone from biomaterials. See also FIGS. 1 and 9-11.

With regard to cellulose derivatives, in some embodiments it is possible that the cellulose derivative is purchased as a commercial product (cellulose acetate CA-398-6 and CA-398-30, cellulose acetate butyrate with commercial name CAB-500-5 and cellulose acetate propionate with commercial name CAP-482-20) and mixed in the solvent before further mixing the cellulose derivative in the solvent with the lignocellulosic material. Also, commercially available cellulose derivatives may further include plasticizers and crosslinkers, such as those described elsewhere herein. However, as described in the Tables below, it is also possible to start with a source of cellulosic material, such as might be found with wood pulp and to carry out a derivatization process wherein a reagent is added to the cellulosic material source to generate a cellulose derivative. Then, the lignocellulosic material (e.g., sawdust) and/or additional cellulosic material is added directly to the cellulose derivative resins (instead of a dried powder) eliminating the need for dissolving cellulosic material in the solvent as part of preparing the cellulose derivative. By way of elaboration and not limitation, it is possible to start with raw fibers that provide a cellulosic material source and then add reagents to treat the fibers to create a cellulose derivative. The most common sources of cellulose are wood fibers, pulp fibers, pulp powder, plant fibers, cotton linters or combination thereof. Cellulose ester derivatives are prepared by reacting cellulose with organic acids, anhydrides and a catalyst. For example, the cellulose fibers are mixed with glacial acetic acid and acetic anhydride with sulfuric acid as a catalyst, resulting in cellulose triacetate. Subsequently, cellulose acetate is prepared by hydrolyzing the trimester to remove some of its acetyl groups. Further, plasticizers may be added to enhance its flexibility. Furthermore, mixed ester of cellulose such as cellulose acetate propionate or butyrate may be produced by substituting propionic acid and propionic anhydride or butyric acid and butyric anhydride for some of the acetic acid and acetic anhydride. Then, the lignocellulosic material can be added directly to the cellulose derivative resin. See also FIGS. 1, and 9-11.

In some embodiments, pulp fibers or pulp powder can be mixed with acetic anhydride, butyric anhydride, or propionic anhydride (1:50, w/w). 0.2 wt % of iodine relative to the total weight added as a catalyst. The mixture can be held at 80° C. for 2 hours. Then, a saturated sodium thiosulfate solution can be added at room temperature under stirring until the color of the mixture changes from dark brown to colorless, indicating the transformation of iodine to iodide. The mixture can be washed with ethanol and water, respectively, in an ultrasonic bath for 1-2 hours to remove any unreacted acetic acid and byproducts. The obtained cellulose acetate can either be directly added to lignocellulosic material (e.g., sawdust) and/or additional cellulosic material or dried at 60° C. in an oven for storage and shipping.

Further, it is also possible to start with a source material of lignocellulose, such as might be found with sawdust, and to carry out a delignification followed by derivatization process to generate a cellulose derivative. The delignification process can be carried out using autohydrolysis treatments, biological treatments, alkaline treatments, chemical treatments, or combinations. For example, the autohydrolysis process can be carried in 1:1 to 1:8 solids to water ration at 70-170° C. in a vessel at atmospheric or high pressure from 2 to 12 hours. The alkaline treatments can be carried by adjusting the pH of the water to alkaline range using sodium bicarbonate, sodium hydroxide, or other base reagents. Biological treatments can be done by using a suitable enzyme. The chemical treatments can be conducted using standard kraft process or sulfite process. Further, bleaching chemicals such as hydrogen peroxide, oxygen, enzymes, chlorine dioxide, hypochlorite, ozone, and other bleaching agents may be used in combinations to whiten the delignified material before derivatization. See also FIGS. 1 and 9-11.

The delignified and bleached cellulosic materials can be derivatized by mixing with acetic anhydride, butyric anhydride, or propionic anhydride (1:50, w/w). 0.2 wt % of iodine relative to the total weight added as a catalyst. The mixture can be held at 80° C. for 2 hours. Then, a saturated sodium thiosulfate solution can be added at room temperature under stirring until the color of the mixture changes from dark brown to colorless, indicating the transformation of iodine to iodide. The mixture can be washed with ethanol and water, respectively, in an ultrasonic bath for 1-2 hours to remove any unreacted acetic acid and byproducts. The obtained cellulose acetate can either be directly added to lignocellulosic material (e.g., sawdust) and/or additional cellulosic material or dried at 60° C. in an oven for storage and shipping. See also FIGS. 1 and 9-11.

In some embodiments, the process can comprise casting, molding, extruding, thermoforming, and/or printing (e.g., 3D printing) the composition and drying the composition. In casting, molding, and/or printing steps, the viscosity of the composition is considered. For example, the composition can be adapted to a desired viscosity range depending on the desired approach for further processing the composition. For example, a paste versus a fluid can be chosen depending on whether the composition will be casted, molded or 3-D printed. The composition has a yield point i.e. it requires certain stress or pressure before it flows and immediately ceases flow after removal of stress or pressure. See also FIGS. 1 and 9-11.

In subsequent steps, drying of the composition can depend on biomaterials formulation, manufacturing methods and the solvent used. By way of example and not limitation drying can be carried out at temperature ranging anywhere from room temperature to about 180° C. In some embodiments drying occurs in a range of about 40° C. to about 120° C. In other embodiments drying occurs in a range of about 40° C. to about 90° C. The boiling point of the solvent again typically dictates drying times and temperatures. Further, density can be affected by drying so in some embodiments slower drying versus faster drying is considered, depending on a desired density for the composition. See also FIGS. 1 and 9-11.

In some embodiments drying occurs at about 120° C. in a compression molding process. The biomaterials formulation, molding pressure, and solvent type typically dictates drying times and temperatures. Further, density, porosity and strength can be affected by compression and drying so in some embodiments slower drying versus faster drying is considered, depending on a desired density, strength and porosity for the composition.

Molding, casting, and/or printing the composition can also be done across a range of temperatures. By way of example and not limitation molding, casting, and/or printing can occur at temperatures ranging from room temperature up to about 40° C. In some embodiments, such as 3-D printing embodiments, solvent evaporation is considered with regard to the printing composition as is a layer by layer printing approach. In some embodiments, such as solvent casting, first cellulose acetate is dissolved in acetone under shear, and then sawdust is added and mixed to obtain the uniform composition of lignocellulosic materials and/or cellulosic material, and cellulose derivative. Further, the composition was casted in a film by spreading it on a glass or TEFLON® coated surface. In some embodiments, 10 wt % cellulose acetate solution in acetone was prepared and then mixed with sawdust in 75 to 25 ratio. Further, hot air oven was used to dry the solvent casted or molded samples at 60° C. In some embodiments, a hardwood bleached pulp was mechanically grinded to micron size particles referred as cellulose powder or cellulosic powder. The cellulose ester was obtained from commercial sources. First, a gram of cellulose acetate is dissolved in 9 grams of acetone and dry cellulose powder is added slowly at different ratios. A blowing agent was also added in selected mixtures. The mixture is casted in a plastic mold and dried at 60° C. in hot air oven before physical and strength testing. Existing commercial processes are capable of capturing solvent (acetone) during drying that can be re-used essentially making this a nearly 100% chemical waste-free production. The formulation of lignocellulose powder or cellulose powder and cellulose acetate materials and processing steps such as drying process can provide final structural properties such as modulus, flexibility, density, water and oil resistance as shown in Table 1 and 2. A higher value of the modulus tensile stress, strain, modulus, load, and OGR (Kit rating) is better while a lower value of WVTR and density is better for strong, durable and lightweight products.

TABLE 1
Mechanical Properties

| | | | Displacement | Load | Stress | Strain | |
|---|---|---|---|---|---|---|---|
| | | | at max | at max | at Max | at max | |
| Sample | | Process and | load | load | load | load | Modulus |
| ID | Composition | Conditions | (mm) | (kN) | (Mpa) | (mm/mm) | (MPa) |
| Invention | Sawdust + | Solvent casting | 0.780 | 0.218 | 101.065 | 0.008 | 22903.9 |
| 1 | Cellulose | followed by | | | | | |
| | Acetate + | compression molding | | | | | |
| | Acetone | at 120° C., 5000 psi | | | | | |
| Invention | Sawdust + | Solvent casting | 0.460 | 0.140 | 64.613 | 0.005 | 20317.5 |
| 2 | Cellulose | followed by | | | | | |
| | Acetate + | compression molding | | | | | |
| | Acetone | at 180° C., 5000 psi | | | | | |
| Invention | Sawdust + | Solvent casting | 0.485 | 0.065 | 30.219 | 0.005 | 10325.6 |
| 3 | Cellulose | | | | | | |
| | Acetate + | | | | | | |
| | Acetone | | | | | | |
| Control 1 | Sawdust + | Powder casting | 0.190 | 0.028 | 12.830 | 0.002 | 10581.5 |
| | Cellulose | followed by | | | | | |
| | Acetate | compression molding | | | | | |
| | | at 120° C., 20000 psi | | | | | |
| Control 2 | Sawdust + | Solvent casting | 0.200 | 0.047 | 21.658 | 0.002 | 9744.9 |
| | Acetone | followed by | | | | | |
| | | compression molding | | | | | |
| | | at 120° C., 5000 psi | | | | | |
| Control 3 | Sawdust | Powder casting | 0.140 | 0.034 | 15.827 | 0.001 | 12842.1 |
| | Only | followed by | | | | | |
| | | compression molding | | | | | |
| | | at 180° C., 20000 psi | | | | | |
| Control 4 | Cellulose | Solvent casting | 0.490 | 0.022 | 10.185 | 0.005 | 1964.6 |
| | Acetate + | followed by | | | | | |
| | Acetone | compression molding | | | | | |
| | | at 120° C., 5000 psi | | | | | |
| Control 5 | Cellulose | Powder casting | 0.420 | 0.006 | 2.891 | 0.004 | 808.2 |
| | Acetate only | followed by | | | | | |
| | | compression molding | | | | | |
| | | at 120° C., 5000 psi | | | | | |

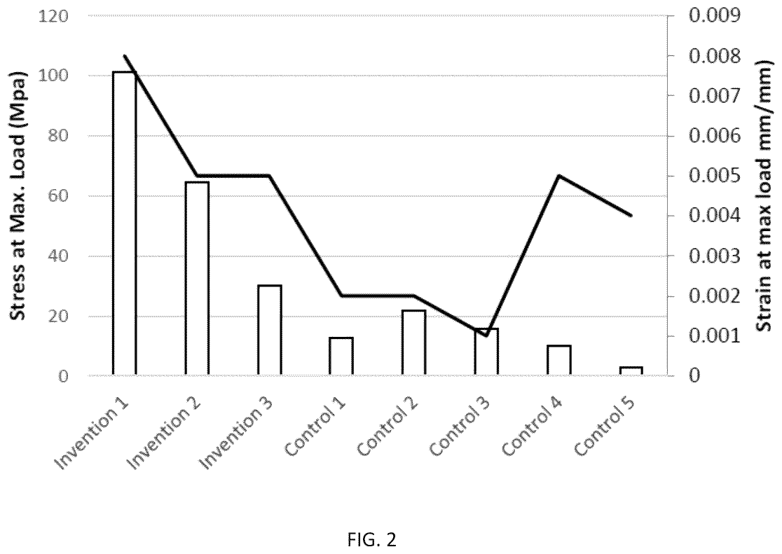

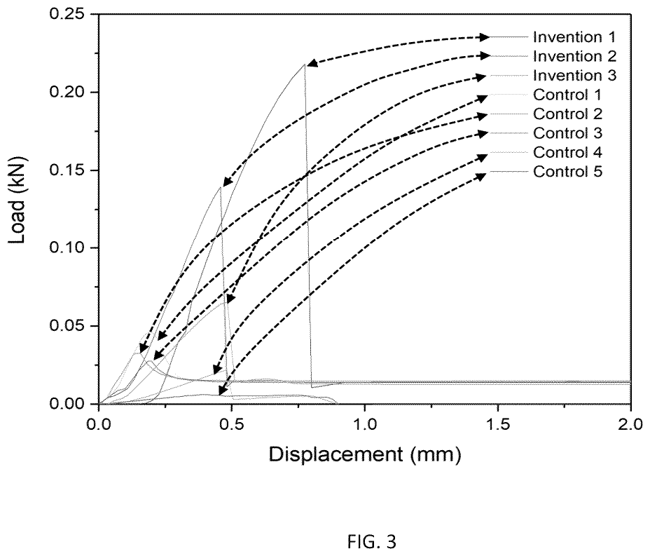

FIG. 2 shows a comparison of the mechanical characteristics (stress and strain at max. load) of various samples corresponding to samples in Table 1. FIG. 3 shows a comparison of the mechanical characteristics (load vs. displacement) of various samples corresponding to samples in Table 1.

TABLE 2
Density, WVTR (Water Vapor Transmission Rate)
and OGR (Oil and Grease Resistance) Properties

| Sample | | Process and | WVTR | OGR | Density | |
|---|---|---|---|---|---|---|
| ID | Composition | Conditions | (g/day/m2/mil) | (Kit Rating) | (g/cm3) | Comment |
| Invention | Sawdust + | Solvent casting | 647.6 | 4 | 0.60 | |
| 1 | Cellulose | followed by | | | | |
| | Acetate + | compression | | | | |
| | Acetone | molding at | | | | |
| | | 120° C., 5000 psi | | | | |
| Invention | Sawdust + | Solvent casting | 732.7 | 5 | 0.68 | |
| 2 | Cellulose | followed by | | | | |
| | Acetate + | compression | | | | |
| | Acetone | molding at | | | | |
| | | 180° C., 5000 psi | | | | |
| Invention | Sawdust + | Solvent casting | 1019.6 | 1 | 0.36 | |
| 3 | Cellulose | | | | | |
| | Acetate + | | | | | |
| | Acetone | | | | | |
| Control 1 | Sawdust + | Powder casting | 991.3 | 1 | 0.97 | Very high |
| | Cellulose | followed by | | | | pressure |
| | Acetate | compression | | | | needed |
| | | molding at | | | | |
| | | 120° C., 20000 psi | | | | |
| Control 2 | Sawdust + | Solvent casting | 1179.6 | 1 | 0.91 | |
| | Acetone | followed by | | | | |
| | | compression | | | | |
| | | molding at | | | | |
| | | 120° C., 5000 psi | | | | |
| Control 3 | Sawdust Only | Powder casting | 1164.4 | 1 | 0.94 | Very high |
| | | followed by | | | | pressure |
| | | compression | | | | needed |
| | | molding at | | | | |
| | | 180° C., 20000 psi | | | | |
| Control 4 | Cellulose | Solvent casting | 1653.5 | 11 | 0.06 | |
| | Acetate + | followed by | | | | |
| | Acetone | compression | | | | |
| | | molding at | | | | |
| | | 120° C., 5000 psi | | | | |
| Control 5 | Cellulose | Powder casting | 1069.3 | 1 | 0.69 | |
| | Acetate only | followed by | | | | |
| | | compression | | | | |
| | | molding at | | | | |
| | | 120° C., 5000 psi | | | | |

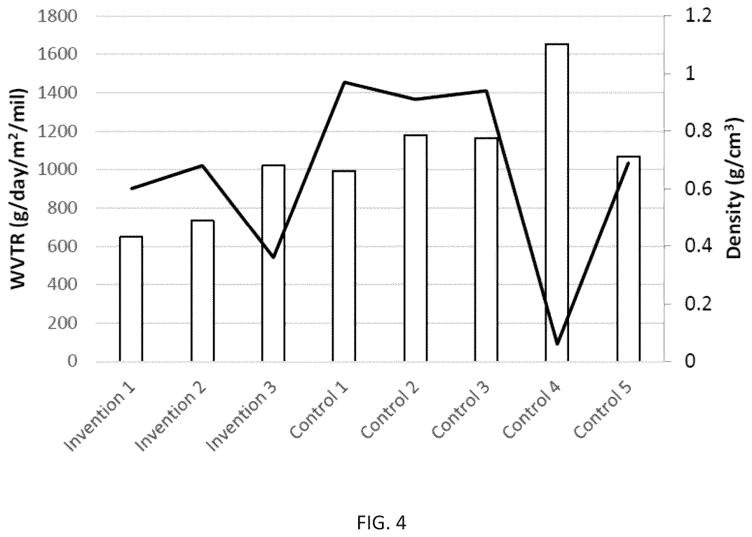

FIG. 4 shows a comparison of the density and water vapor transmission rate (WVTR) characteristics of the various samples corresponding to samples in Table 2.

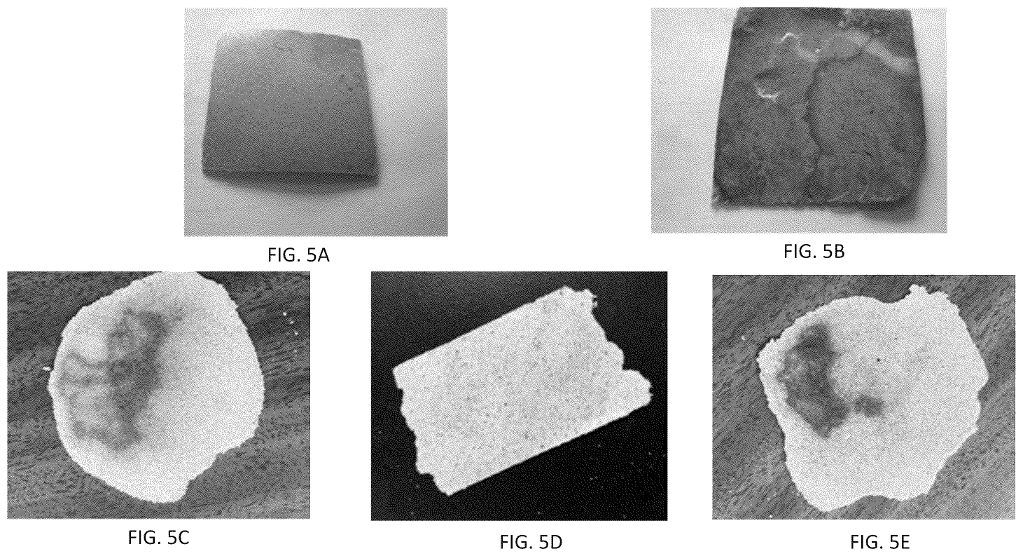

Referring to FIGS. 5A and 5B, photographs of Inventions 1 and 2, respectively, from Tables 1 and 2 are shown. FIGS. 5C through 5G show Controls 1-5, respectively, from Tables 1 and 2.

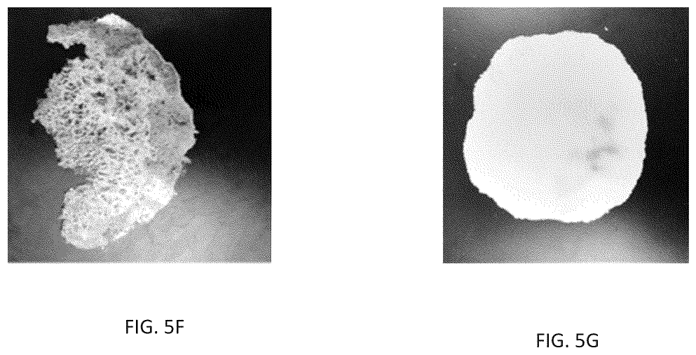

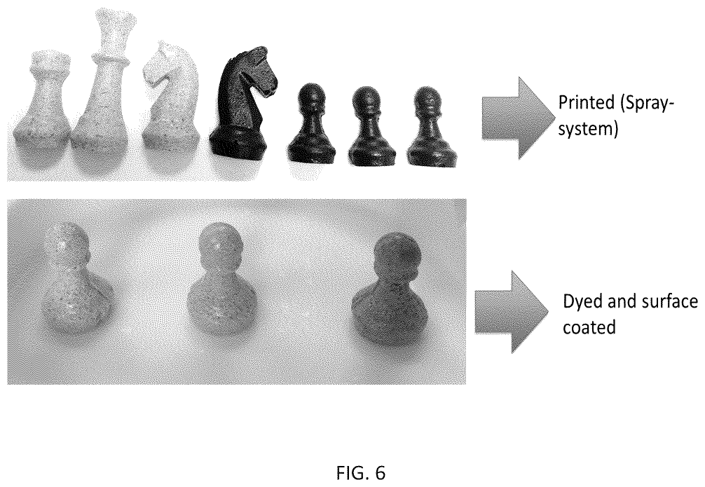

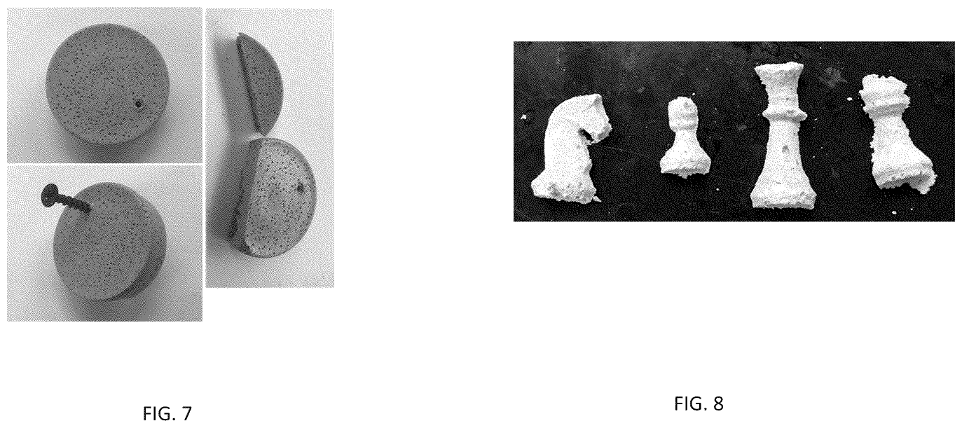

FIG. 6 shows solvent molded and printed (spray system) or dyed and surface coated pieces. The printing was carried using a carbon black spray paint whereas dying was done using riboflavin and PERGASOL red. Further, the samples were dip coated in cellulose derivative solution and dried at room temperature. FIG. 7 shows machinability (drilled, cut and rubbed) of solvent casted pieces. FIG. 8 shows solvent molded pieces containing additives such as triethyl citrate (TEC) and ethylated starch.

By way of a particular, non-limiting example, saw dust and other biomass residues from wood and agricultural waste are prepared in micron size particles, referred to as lignocellulose powder. In some embodiments, standard cellulose esters from commercial sources are evaluated, as are cheaper derivatization options. In some embodiments, a process in accordance with the presently disclosed subject matter comprises first dissolving the cellulose esters powder in a solvent, such as acetone solvent, and then mixing with dry lignocellulose powder or cellulose powder under agitation. The mixture is casted in a plastic mold and dried at 50° C. in a hot air oven before physical and strength testing. Existing commercial processes are capable of capturing solvent (e.g., acetone) during drying, which can be re-used, making embodiments of the presently disclosed subject matter nearly chemical waste-free production. The ratio of lignocellulose powder and/or cellulose powder, and cellulose esters materials and the drying process can provide desired structural properties such as density, porosity, compression strength, and flexibility. Representative, non-limiting examples of ratios are shown in the Figures. A blowing agent is also added in selected mixtures.

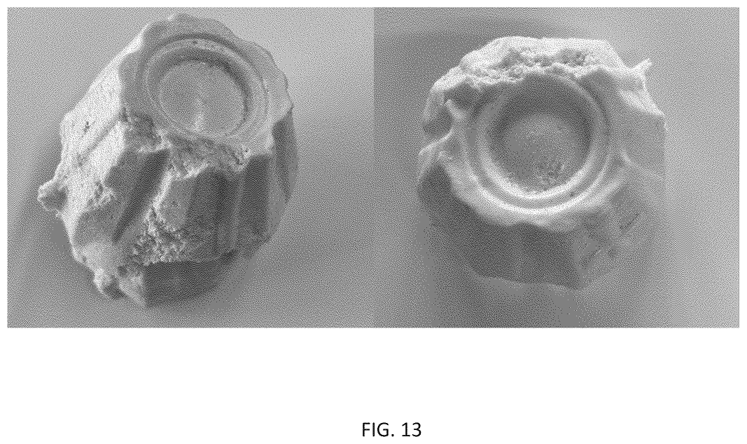

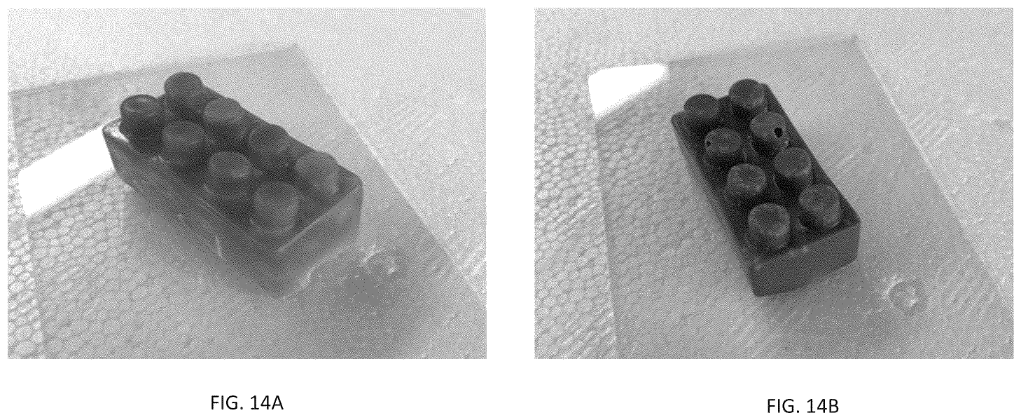

Referring to FIG. 13, shown is a cellulose material obtained by grinding pulp fibers into powder mixed with cellulose derivative and mold casted, e.g., mold casted cellulose material/cellulose derivative (3:1). In some embodiments, RSD/CA composite bioplastics are provided. To elaborate, FIGS. 14A and 14B show solvent casted flexible blocks prepared from Refined Sawdust/Cellulose Acetate (1:1) (FIG. 14A) and Refined Sawdust/Cellulose Acetate (3:1) (FIG. 14B). The refined sawdust (RSD) was added to a 10 weight percentage (wt %) CA solutions to prepare the composite RSD/CA resins with 5.0 wt % of triethyl citrate plasticizing agent and 2.0 wt % of citric acid crosslinking agent with respect to the total solid weight. The samples were dried under 40° C. for 6 hours followed by heat treatment at 120° C. for 10 min to induce crosslinking. The mold casted samples are highly flexible and smooth in the surface structure. While it is not desired to be bound by any particular theory of operation, it is believed that this is because sawdust particles are grinded into much smaller size that can be closely packed. The sizes of the sawdust refined using the Wiley mill grinder are compared in FIG. 12, showing that longer grinding time leads to finer sawdust powder.

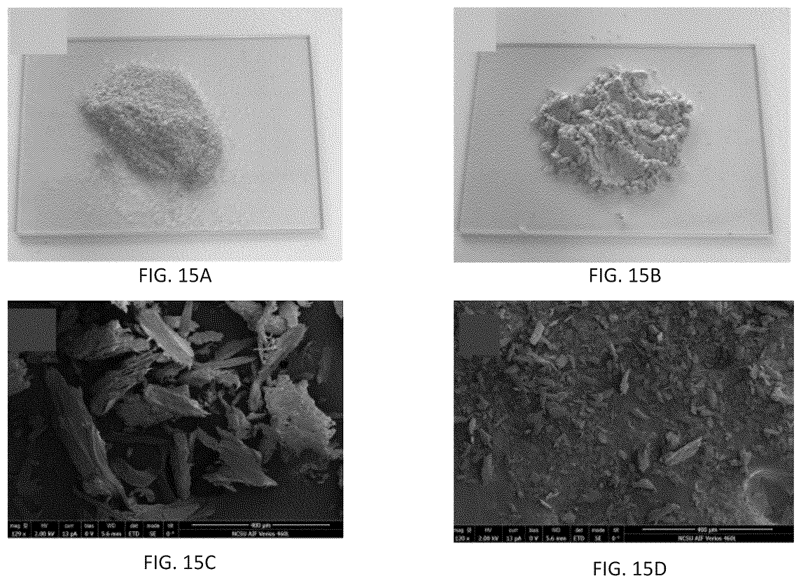

The sawdust particles were further grinded using Flacktek SpeedMixer™ (2000 RPM in 4 min cycle for a total of 1 hour). A comparison of control sawdust (grinded using Wiley mill grinder) and RSD (grinded using the Wiley mill grinder followed by Flacktec SpeedMixer™) is shown in FIGS. 15A and 15B. SEM images of the two types of sawdust in FIGS. 15C and 15D shows that the sawdust grinded by Flacktec SpeedMixer™ are at a size of a few micrometers. In some embodiments, after grinding sawdust with the Wiley mill followed by Flacktek mixer, the lignocellulosic material and/or the cellulosic material comprises 90% of particles ranging from 0.01 to 5 mm in size.

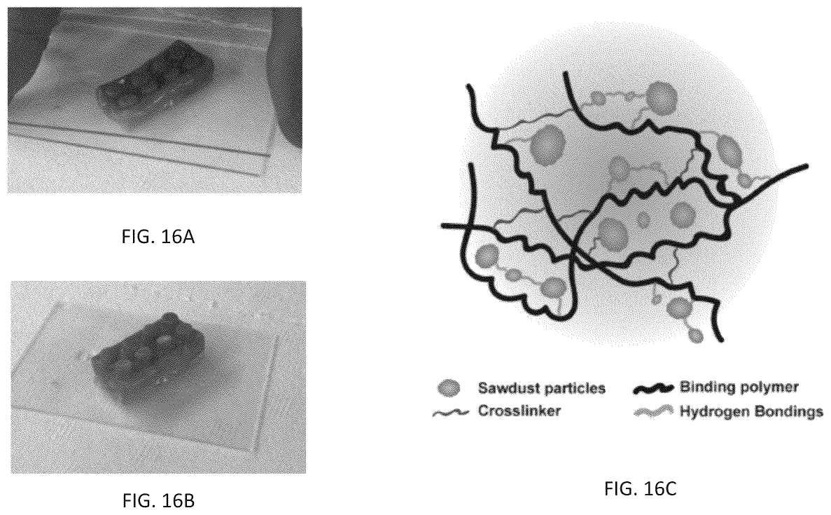

FIGS. 16A and 16B show the RSD/CA sample with and without pressure. After pressure is released, the RSD/CA sample can reverse to its original shape. While it is not desired to be bound by any particular theory of operation, it is believed that this is because sawdust particle, cellulose acetate, crosslinking agent, and TEC forms a 3D network that provide flexibility and dimensional stability as shown schematically in FIG. 16C.

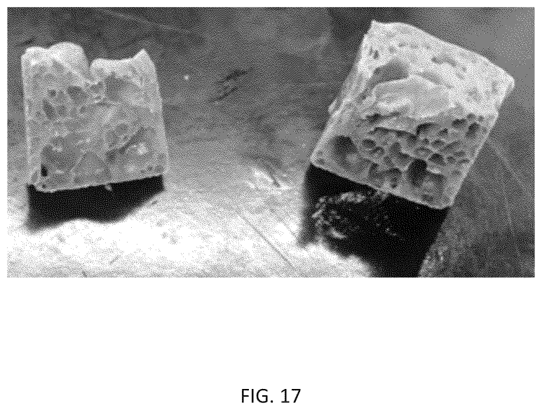

FIG. 17 shows the cross-section of RSD/CA block samples. As can be seen from cross-section images, RSD/CA blocks are highly porous. The porous structure is considered to be formed when the acetone evaporates from the substrate during the drying process. With further control in the drying and evaporation conditions, the porosity can be adjusted.

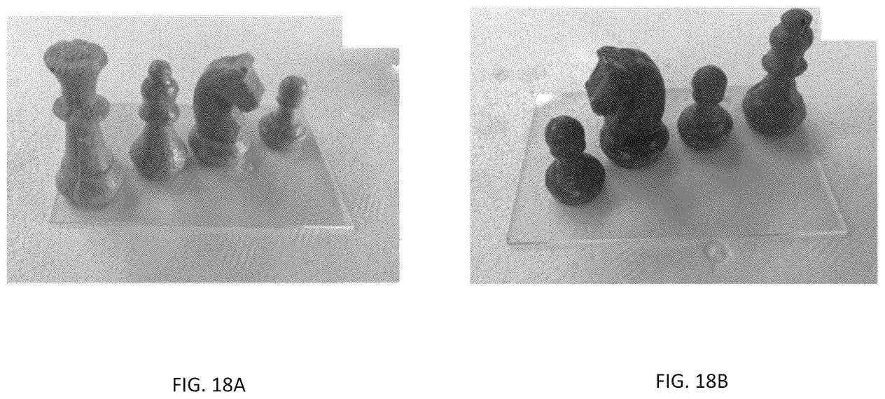

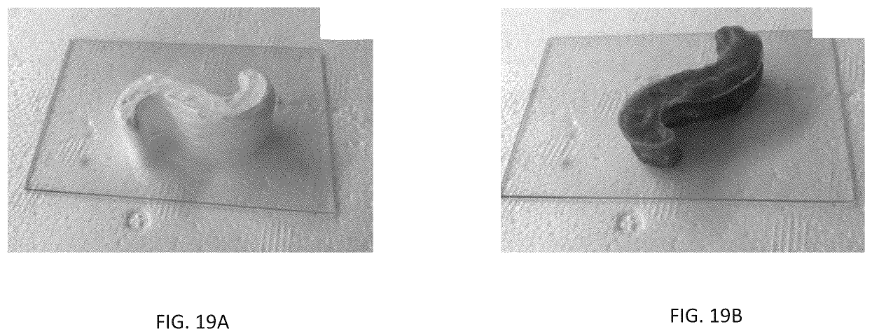

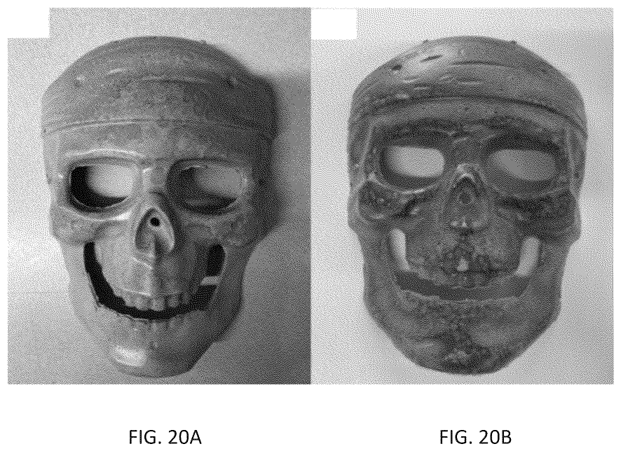

Referring to FIGS. 18A, 18B, 19A, 19B, 20A, and 20B, the prepared RSD/CA resin can be mold casted into various objects, including chess pieces, packing peanuts, and cosmetic masks. FIGS. 18A and 18B show mold casted SD/CA chess pieces and mold casted RSD/CA chess pieces, respectively. FIGS. 19A and 19B show the comparison of polystyrene packing peanut and mold casted RSD/CA packing peanut. The ultralight weight and flexibility of RSD/CA packing peanut provide the potential as a replacement material to the traditional petroleum-based polymers for packaging materials. FIGS. 20A and 20B show the comparison of SD/CA mask and RSD/CA mask. Finer surface as obtained for RSD/CA mask. RSD/CA mask is relatively more flexible.

Thus, in some embodiments, the presently disclosed subject matter provides compositions having one or more of the following characteristics: light weight (low density); tunable porosity, strength, and flexibility; moldable/printable; and/or low cost.

The presently disclosed compositions provide sustainable bioproducts such as packaging and construction products, etc. Thus, a range of end uses for the compositions of the presently disclosed subject matter are provided. For example, any end-use where paper is currently implemented can be a possible end use, including paper cups, paper plates, and other disposable food service items. Also, the presently disclosed compositions can be employed in the construction industry including for example as drywall or as insulation. It is possible to print color on any texture of the composition to facilitate use in the construction industry. Also, the compositions of the presently disclosed subject matter are machinable.

Additional end uses could also include as structural support for automobiles in view of the lightweight aspects of the compositions of the presently disclosed subject matter. Additionally, agricultural applications are provided, including uses as greenhouse trays for seedlings to replace plastic trays. The compositions of the presently disclosed subject matter are biodegradable and can be used, for example, by an organic farmer wherein a flowerpot or a plant pot comprising the presently disclosed subject matter could be planted directly in the soil.

Aspects of the presently disclosed subject matter thus include transforming low-value waste industrial byproducts (sawdust and other biomass waste) into high-value sustainable and innovative packaging materials that will not only lead to dramatic reduction in the footprint of present-day plastic pollution but also reduce the solid waste accumulation generated from wood and other biomass.

### References

All references listed below, as well as all references cited in the instant disclosure, including but not limited to all patents, patent applications and publications thereof, scientific journal articles, and database entries are incorporated herein by reference in their entireties to the extent that they supplement, explain, provide a background for, or teach methodology, techniques, and/or compositions employed herein.
1) 1millionwomen.com.au/blog/why-you-should-say-no-styrofoam
2) International Agency for Research on Cancer (IARC)—Summaries & Evaluations, inchem.org/documents/iarc/vol82/82-07.html
3) Review of the Styrene Assessment in the National Toxicology Program 12th Report on Carcinogens (2014) Board on Environmental Studies and Toxicology
4) latimes.com/opinion/editorials/la-ed-polystyrene-bans-20160713-snap-story.html
5) Graca, B., Bełdowska, M., Wrzesień, P., & Zgrundo, A. (2013). Styrofoam debris as a potential carrier of mercury within ecosystems. Environmental science and pollution research international, 21(3), 2263-2271.
6) Rios L M, Moore C, Jones P R. Persistent organic pollutants carried by synthetic polymers in the ocean environment. Mar Pollut Bull. 2007; 54:1230-1237. doi:10.1016/j.marpolbul.2007.03.022.
7) Polystyrene is killing our coasts. California needs to turn off the trash tap on foam takeout containers, latimes.com/opinion/editorials/la-ed-polystyrene-bans-20160713-snap-story.html
8) theguardian.com/sustainable-business/2015/jan/22/new-york-styrofoam-ban-foam-packaging-food-restaurants
9) Haggith, M., Kinsella, S., Baffoni, S., Anderson, P., Ford, J., Leithe, R., Neyroumande, E., Murtha, N., and Tinhout, B. “The State of the Global Paper Industry 2018” (2018):536
10) FAO. “The Outlook for Pulp and Paper to 1995. Paper Products, and Industrial Update', Food and Agricultural 537 Organization of the United Nations” (1996)
11) Peter A. Signoretti. “The Future of Functional and Barrier Coatings for Paper and Board to 2022” (2017): Available at smitherspira.com/industry-market-reports/paper/the-future-of-functional-and-barrier-coatings.
12) Hannah Ritchie and Max Roser (2018)—“Plastic Pollution”. OurWorldInData.org. ourworldindata.org/plastic-pollution'
13) Geyer, R., Jambeck, J. R., & Law, K. L. (2017). Production, use, and fate of all plastics ever made. Science Advances, 3(7), e1700782. advances.sciencemag.org/content/3/7/e1700782.
14) D. K. A. Barnes; F. Galgani; R. C. Thompson; M. Barlaz, Accumulation and fragmentation of plastic debris in global environments, Philosophical Transactions of the Royal Society B-Biological Sciences, 364, 1985-1998 (2009).
15) M. Cole; P. Lindeque; C. Halsband; T. S. Galloway, Microplastics as contaminants in the marine environment: A review, Marine Pollution Bulletin, 62, 2588-2597 (2011).
16) J. A. I. do Sul; M. F. Costa, The present and future of microplastic pollution in the marine environment, Environmental Pollution, 185, 352-364 (2014).
17) D. Sidiras, F. Batzias, E. Schroeder, R. Ranjan, M. Tsapatsis, Dye adsorption on autohydrolyzed pine sawdust in batch and fixed bed systems Chem. Eng. J., 171 (2011), pp. 883-896
18) S. Bratkovich, J. Howe, J. Bowyer, E. Pepke, M. Frank, K. Fernholz (2014) Municipal Solid Waste (Msw) and Construction and Demolition (C&D) Wood Waste Generation and Recovery in the United States, dovetailinc.org/report_pdfs/2014/dovetailwoodrecovery0914.pdf
19) Waste Timeline: Decomposition and degre Decomposition* and degradation* times for all waste varies depending on the environment; exposure to oxygen, water, air, acids, bases, temperature and living organisms will all affect the time, tdsb.on.ca/Portals/ecoschools/docs/Waste%20Timeline.pdf
20) International Agency for Research on Cancer (IARC)—Summaries & Evaluations, http://www.inchem.org/documents/iarc/vol82/82-07.html
21) Review of the Styrene Assessment in the National Toxicology Program 12th Report on Carcinogens (2014) Board on Environmental Studies and Toxicology
22) Rios L M, Moore C, Jones P R. Persistent organic pollutants carried by synthetic polymers in the ocean environment. Mar Pollut Bull. 2007; 54:1230-1237. doi:10.1016/j.marpolbul.2007.03.022.
23) New York restaurants scramble for alternatives after city bans foam packaging
24) Polystyrene (PS): Production, Market, Price and its Properties. https://www.plasticsinsight.com/resin-intelligence/resin-prices/polystyrene/
25) Expanded Polystyrene (EPS) Market-Forecasts from 2018 to 2023, businesswire.com/news/home/20180405006046/en/Global-17.66-Billion-Expanded-Polystyrene-EPS-Market
26) CA cellulose acetate/CA resin/Granules raw material with best price, alibaba.com/product-detail/CA-cellulose-acetate-CA-resin-Granules_60781349706.html?spm=a2700.7724857.normalList.7.517a6bfdK WdW67

It will be understood that various details of the presently disclosed subject matter can be changed without departing from the scope of the presently disclosed subject matter. Furthermore, the foregoing description is for the purpose of illustration only, and not for the purpose of limitation.

What is claimed is:

1. A composition comprising (a) a lignocellulosic material and/or a cellulosic material; and (b) a cellulose derivative.

2. The composition according to claim 1, wherein the lignocellulosic material and/or the cellulosic material comprises 90% of particles ranging from 0.01 to 5 mm in size.

3. The composition according to claim 1, wherein the lignocellulosic material is derived from a biomass residue and/or the cellulosic material is derived from a biomass residue.

4. The composition according to claim 3, wherein the biomass residue is selected from the group consisting of a wood biomass residue, such as saw dust; an agricultural biomass residue, such as hemp hurds; and combinations thereof.

5. The composition according to claim 1, wherein the cellulose derivative comprises a cellulose ester.

6. The composition according to claim 1, further comprising a solvent to dissolve cellulose derivative.

7. The composition according to claim 1, wherein the lignocellulosic material and/or the cellulosic material, and the cellulose derivative are provided at a ratio ranging from 90:10 lignocellulosic material and/or cellulosic material:cellulose derivative to 10:90 lignocellulosic material and/or cellulosic material:cellulose derivative.

8. The composition according to claim 1, further comprising a blowing agent, a dye or other colorant, a cross-linking agent, a plasticizing agent, a release agent, a dry strength agent, a wet strength agent, an enzyme, a nanomaterial, a nanobiomaterial, a rheology modifier, a filler, and combinations thereof.

9. The composition according to claim 1, characterized as a biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, extrudable biomaterial, solvent extrudable biomaterial, reactive extrudable biomaterial, thermoformable biomaterial, solvent thermoformable biomaterial, thermoformable biomaterial, and combination thereof.

10. A process for preparing a composition, the process comprising providing a cellulose derivative in a solvent; and mixing a lignocellulosic material and/or a cellulosic material into the solvent.

11. The process according to claim 10, wherein the lignocellulosic material and/or the cellulosic material comprises 90% of particles ranging from 0.01 to 5 mm in size.

12. The process according to claim 10, wherein the lignocellulosic material and/or the cellulosic material is derived from a biomass residue.

13. The process according to claim 12, wherein the biomass residue is selected from the group consisting of a wood biomass residue, such as saw dust; an agricultural biomass residue, such as hemp hurds; and combinations thereof.

14. The process according to claim 10, wherein the cellulose derivative comprises a cellulose ester.

15. The process according to claim 10, wherein the lignocellulosic material and/or the cellulosic material, and cellulose derivative are provided at a ratio ranging from 90:10 lignocellulosic material and/or cellulosic material:cellulose derivative to 10:90 lignocellulosic material and/or cellulosic material:cellulose derivative.

16. The process according to claim 10, further comprising adding a blowing agent, a dye or other colorant, a cross-linking agent, a plasticizing agent, a release agent, a dry strength agent, a wet strength agent, an enzyme, a nanomaterial, a nanobiomaterial, a rheology modifier, a filler and combinations thereof.

17. The process according to claim 10, wherein the solvent comprises acetone.

18. The process according to claim 10, comprising dissolving the cellulose derivative in the solvent and then mixing the lignocellulosic material and/or the cellulosic material into the solvent.

19. The process according to claim 10, wherein mixing the lignocellulosic material into the solvent occurs under agitation and/or shear.

20. The process according to claim 10, comprising casting the composition in a mold and/or drying the composition.

21. The process according to claim 20, comprising recovering the solvent.

22. The process according to claim 10, wherein the composition is characterized as a biomaterial, castable biomaterial, solvent castable biomaterial, moldable biomaterial, solvent moldable biomaterial, 3D printable biomaterial, solvent 3D printable biomaterial, solvent castable and moldable biomaterial, solvent castable and compression moldable biomaterial, extrudable biomaterial, solvent extrudable biomaterial, reactive extrudable biomaterial, thermoformable biomaterial, solvent thermoformable biomaterial, thermoformable biomaterial, and combination thereof.

23. The process according to claim 12, wherein the biomass residue is milled, refined, grinded, milled, cryomilled, hammer milled, screened, sieved or combinations thereof.

24. The composition according to claim 3, wherein the biomass residue is milled, refined, grinded, milled, cryomilled, hammer milled, screened, sieved or combinations thereof.
